(19) United States
(12) Patent Application Publication
(10) Pub. No.: US 2010/0018421 A1
(43) Pub. Date: Jan. 28, 2010

(54) ROLLER WITH MICROSTRUCTURE AND THE MANUFACTRUING METHOD THEREOF

(75) Inventors: Kun-Chih Pan, Taichung County (TW); Fuh-Yu Chang, Hsinchu County (TW); Min-Chieh Chou, Taipei City (TW)

Correspondence Address: WPAT, PC;INTELLECTUAL PROPERTY ATTORNEYS, 7225 BEVERLY ST., ANNANDALE, VA, 22003, US

(73) Assignee: Industrial Technology Research Institute, Hsin-Chu (TW)

(21) Appl. No.: 12/571,734

(22) Filed: Oct. 1, 2009

Related U.S. Application Data
(63) Continuation of application No. 11/258,020, filed on Oct. 26, 2005.

(30) Foreign Application Priority Data
Mar. 11, 2005 (TW) 094107479

(51) Int. Cl. B41F 13/10

(52) U.S. Cl. 101/377

(57) ABSTRACT

The present invention discloses a method for manufacturing a roller with microstructure, comprising the steps of: forming a protective metal layer on a roller; defining specific imprint patterns on an imprint stamp by processing the imprint stamp with a flexible mold; forming an etch mask on the embossed imprint stamp after the imprint stamp is released from the mold; wetting the imprint stamp and the etch mask thereof; adhering the etch mask onto the roller by rolling the roller on the imprint stamp; etching the roller at the portion thereof uncovered by the etch mask; and forming the roller with specific microstructure by removing the etch mask and the protective metal layer.

### FIELD OF THE INVENTION

The present invention relates to a roller with microstructure and the manufacturing method thereof, and more particularly, to a method for replicating planar micro-scale imprint patterns of monomer onto a cylinder-shaped substrate as etch mask thereof by a soft lithography process, by which the forming of microstructure on a solid substrate can be achieved and the cylinder-shaped substrate, i.e. a roller, can be etched at the portion thereof uncovered by the etch mask so as to form a roller with microstructure. Moreover, the roller with microstructure of the present invention can be applied in the manufacturing of flexible printed circuit board (FPC).

### BACKGROUND OF THE INVENTION

For the manufacturing industry, roller is an indispensable device. It not only can be used for transporting and pressing, but also can be processed into a gear and used for power transmission. As for the processing of the profile of a roller, it is common in the prior art to use a Computer Numerical Control (CNC) machine like a milling machine or a lathe for the processing and forming microstructure on a metal roller. However, the prior art processing is limited by the moving path defined by the abovementioned CNC machines that only linear finishing can be achieved, in addition, the prior art processing is also limited by the size of the finishing tools of the CNC machines that micro-scale patterns formed with ultra-precision finishing is not feasible. From the above description, it is noted that the patterns and the size thereof formed on the roller are adversely restricted by the prior-art processing method. Consequently, there is a need for a processing method that can form any patterns of micro-scale on a roller.

### SUMMARY OF THE INVENTION

It is the primary object of the invention to provide a roller with microstructure and the manufacturing method thereof, for replicating planar micro-scale imprint patterns of monomer onto a cylinder-shaped substrate as etch mask thereof using a soft lithography process, by which the forming of microstructure on a solid substrate can be achieved and the cylinder-shaped substrate, i.e. a roller, can be etched at the portion thereof uncovered by the etch mask so as to form a roller with microstructure. Moreover, the roller with microstructure of the present invention can be applied in the manufacturing of flexible printed circuit board (FPC).

It is another object of the invention to provide a method for forming micro-scale patterns of various shapes, such as circle, polygon, line, etc. on a roller by lithography that can be performed with simply process and low-cost equipments.

To achieve the above objects, the present invention provides a method for manufacturing a roller with microstructure, comprising the steps of:
forming a protective metal layer on a roller;
defining specific imprint patterns on an imprint stamp by processing the imprint stamp with a flexible mold;
forming an etch mask on the embossed imprint stamp after the imprint stamp is released from the mold;
wetting the imprint stamp and the etch mask thereof;
adhering the etch mask onto the roller by rolling the roller on the imprint stamp;
etching the roller at the portion thereof uncovered by the etch mask; and
forming the roller with specific microstructure by removing the etch mask and the protective metal layer.

To achieve the above objects, the present invention provides a roller with microstructure, which is formed by the abovementioned manufacturing method.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a steel roller prepared for forming microstructure thereon according to the present invention.

FIG. 2 is a schematic view showing the forming of a protective metal layer on the steel roller of FIG. 1 according to the present invention.

FIG. 3 is a schematic view showing the defining of specific imprint patterns on an imprint stamp by processing the imprint stamp with a flexible mold according to the present invention.

FIG. 4 is a schematic view showing the forming of an etch mask on the embossed imprint stamp after the imprint stamp is released from the mold according to the present invention.

FIG. 5 is a schematic view showing the wetting of the imprint stamp and the etch mask thereof according to the present invention.

FIG. 6 is a schematic view showing the adhering of the etch mask onto the roller by rolling the roller on the imprint stamp according to the present invention.

FIG. 7 is a schematic view showing a roller with patterned etch mask attached thereon according to the present invention.

FIG. 8 is a schematic view showing the etching of the protective metal of the roller at the portion thereof uncovered by the etch mask according to the present invention.

FIG. 9 is a schematic view showing the etching of the roller at the portion thereof uncovered by the etch mask according to the present invention

FIG. 10 is a schematic view showing the forming of the roller with specific microstructure by removing the etch mask and the protective metal layer according to the present invention.

FIG. 11 is a schematic view showing the production of FPC by the pressing of the roller with microstructure according to the present invention.

FIG. 12 is a flowchart depicting the manufacturing method of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

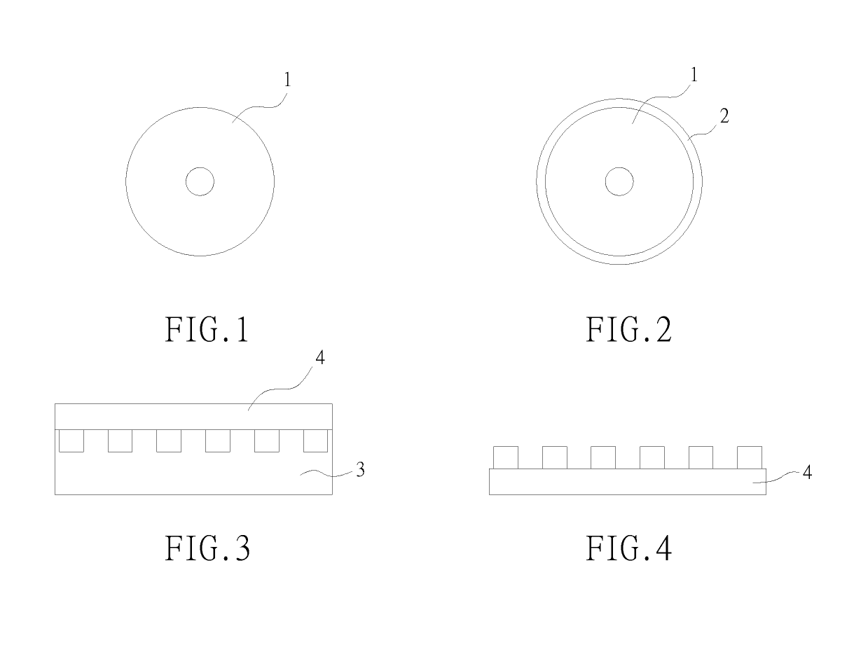

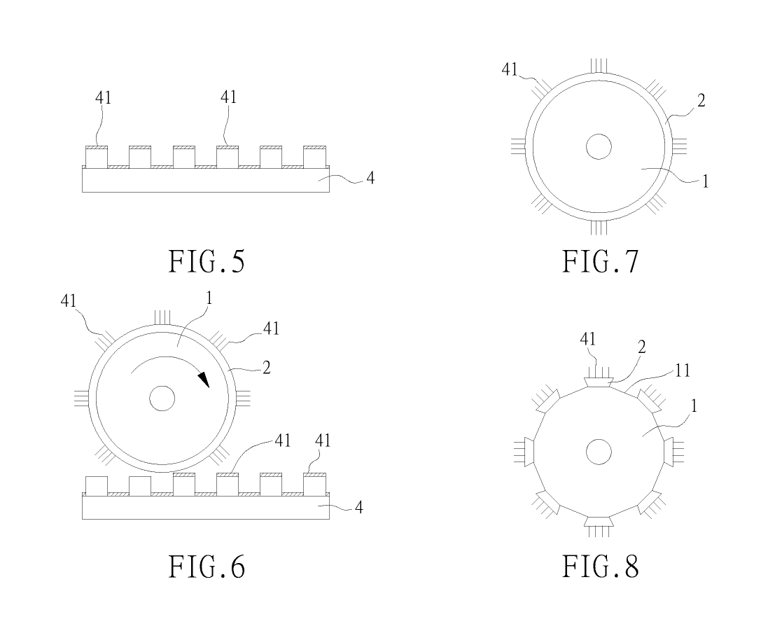

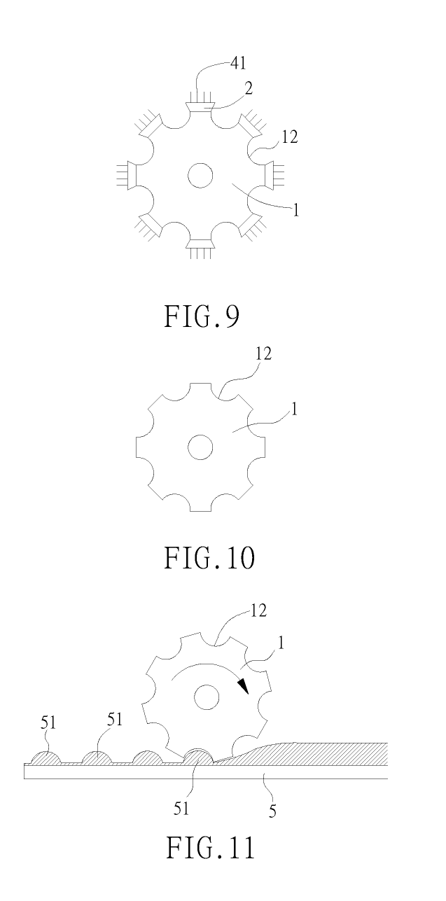

Please refer to FIGS. 1-11, which are schematic diagrams showing the complete process of producing a roller with microstructure according to the present invention. In FIG. 1, a steel roller 1 is provided that are going to be processed for forming specific imprint patterns on the surface thereof. In FIG. 2, a protective metal layer 2 is formed on the steel roller 1 such that it can be used for protecting a predetermined portion of the roller 1 from etching by a posterior etch process. In FIG. 3, the formation of the specific imprint patterns on an imprint stamp 4 is processed by pressing a silicon mold 3 with the embossed specific imprint patterns on the imprint stamp 4, wherein the imprint stamp 4 is made of Polydimethyl Siloxane (PDMS) and the imprint stamp 4 after being pressed by the silicon will become a imprint stamp 4 having a complementary image of the specific imprint patterns of the silicon mold 3. In FIG. 4, a layer of etch mask 41 made of Self-Assembly Monomer (SAM) is formed on the imprint stamp 4 embossed with the specific patterns after the imprint stamp 4 is released and detached from the silicon mold 3. In FIG. 5, the imprint stamp 4 along with the etch mask 41 formed thereon is wetted so as to increasing the adhesive of the etch mask 41, wherein the etch mask 41 is a layer having a complementary image of the specific imprint patterns of the imprint stamp and is preferred made of monomer. As seen in FIG. 6 and FIG. 7, the rolling of the roller 1 on the patterned stamp 4 enables the etch mask 41 of imprint patterns complementary to that of the flexible mold 3 to adhere on the roller 1 and thus to form a patterned layer of monomer on the protective metal layer 2 of the roller 1. In FIG. 8, the portion of the roller 1 not covering by the etch mask 41 is etched out by an etching method so that a first etching groove 11 is formed. In FIG. 9 and FIG. 10, the portion of the first etching groove 11 of the roller 1 is further etched for forming a second etching groove 12 and then the etch mask 41 and the protective metal layer 2 are removed from the roller 1 such that a roller with microstructure is formed. Please refer to FIG. 11, while the roller 1 with microstructure is being applied to produce FPC 5, the roller 1 is used to roll and press on a flexible film so that a pattern 51 can be formed thereon. As shown in FIGS. 9-11, the second etching groove 12 has a curved cross section which is made by a mechanical process taught by the present invention.

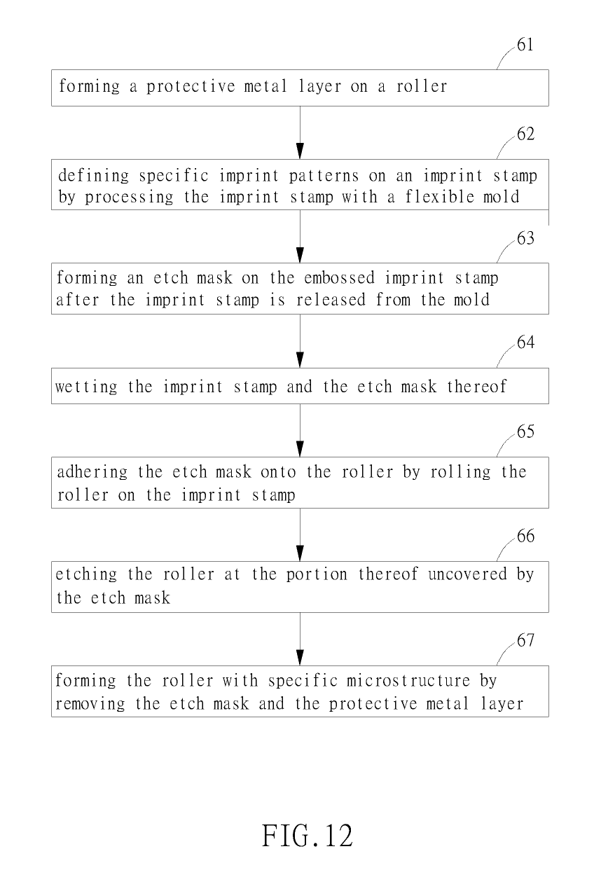

Please refer to FIG. 12, which a flowchart depicting the manufacturing method of the present invention. As seen n FIG. 12, the method for manufacturing a roller with microstructure comprises the steps of:
61 forming a protective metal layer on a roller;
62 defining specific imprint patterns on an imprint stamp by processing the imprint stamp with a flexible mold;
63 forming an etch mask on the embossed imprint stamp after the imprint stamp is released from the mold;
64 wetting the imprint stamp and the etch mask thereof;
65 adhering the etch mask onto the roller by rolling the roller on the imprint stamp;
66 etching the roller at the portion thereof uncovered by the etch mask; and
67 forming the roller with specific microstructure by removing the etch mask and the protective metal layer.

From the above description, it is noted that the present invention is primarily adapted for FPC production, that provides a method for replicating planar micro-scale imprint patterns of monomer onto a cylinder-shaped substrate as etch mask thereof by a soft lithography process so as to enable the forming of microstructure on a solid substrate to be achieved by an etching means, that is, to enable the roller to be etched at the portion thereof uncovered by the etch mask so as to form a roller with microstructure. Moreover, the invention provides a method for forming micro-scale patterns of various shapes, such as circle, polygon, line, etc. on a roller by lithography that can be performed with simply process and low-cost equipments.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An roller structure for forming the roller structure comprising:
a cylindrical roller with a first end, a second end, and rolling surface, wherein the roller's axis connecting the first end and the second end;
a metal layer on the rolling surface of the roller;
a plurality of etch marks on the metal layer; and
a plurality of etch grooves on the rolling surface of the roller, wherein the etch grooves are located among the etch marks and each of the etch grooves connecting the first end to the second end.

2. The roller structure according to claim 1, wherein the etch grooves are etching into the metal layer and on the rolling surface of the roller.

3. The roller structure according to claim 1, where the roller is made of steel.

4. The roller structure according to claim 1, wherein the etch grooves are etching into the roller and below the rolling surface of the roller.
